(19) United States
(12) Patent Application Publication
(10) Pub. No.: US 2020/0043399 A1
(43) Pub. Date: Feb. 6, 2020

(54) TRANSMISSION CIRCUIT FOR TRANSMITTING DIFFERENTIAL SIGNALS AND DISPLAY DEVICE USING THE SAME

(71) Applicant: YU-JEN CHEN, (US)

(72) Inventor: YU-JEN CHEN, (US)

(21) Appl. No.: 15/740,003

(22) PCT Filed: Apr. 27, 2017
(86) PCT No.: PCT/CN2017/082271

§ 371 Date: Dec. 27, 2017

(30) Foreign Application Priority Data
Mar. 24, 2017 (CN) 201710185897.3

(51) Int. Cl. G09G 3/20; G09G 3/36

(52) U.S. Cl. CPC G09G 3/2092; G09G 2370/14; G09G 3/36

(57) ABSTRACT

A transmission circuit for transmitting differential signals and a display device using the same are provided. The transmission circuit for transmitting differential signals includes a transmitter, a receiver, and a transmission line. The transmission line is connected with the transmitter and the receiver. The transmitter converts a received logic signal of an unbalanced transmission into a differential signal of a balanced transmission. The receiver converts the received differential signal of the balanced transmission into the logic signal of the unbalanced transmission. The receiver is integrated with a plurality of terminal matching resistors.

### CROSS-REFERENCE TO RELATED APPLICATION

This application claims the benefit of China Patent Application No. 201710185897.3, filed on Mar. 24, 2017, in the State Intellectual Property Office of the People's Republic of China, the disclosure of which is incorporated herein in its entirety by reference.

### FIELD OF THE INVENTION

The present disclosure relates to the technical field of signal transmission, and more particularly to a transmission circuit for transmitting differential signals and a display device using the same.

### BACKGROUND OF THE INVENTION

In the field of flat-panel displays, for example, LCD panels, the resolution requirements are getting higher and higher, so there are a large number of connections between a driving board and a display panel. This will increase the installation space, and a large number of interconnections will bring more serious electromagnetic interference.

A transmission circuit for transmitting differential signals provides not only high bandwidth with very low electromagnetic interference but also more data interfaces integrated with the compact structure, so that LCD panels are thinner and have a better transmission effect.

A transmission circuit for transmitting differential signals comprises a transmitter, an interconnecting device, and a receiver. The transmitter is disposed at the driving board side of a circuit board. The receiver is disposed at the display panel side of the circuit board. The transmitter converts an unbalanced logic signal output from a master control chip of the driving board into a balanced differential signal, and then the signal is transmitted to the receiver at the display panel side via the interconnecting device. The receiver converts the balanced differential signal into an unbalanced transmission logic signal to be transmitted to a sequential control and row and column driving circuit of the display panel. The interconnecting device includes a connecting line (a cable or traces on a printed circuit board) and a terminal matching resistor. The terminal matching resistor is generally disposed on the printed circuit board, which results in excess components on the printed circuit board. Besides, the cost of the matching resistor is higher.

### SUMMARY OF THE INVENTION

The primary object of the present disclosure is to provide a transmission circuit for transmitting differential signals which is simple and cost-effective.

According to one aspect of the present disclosure, a transmission circuit for transmitting differential signals is provided. The transmission circuit for transmitting differential signals comprises a transmitter, a receiver, and a transmission line. The transmission line is connected with the transmitter and the receiver. The transmitter converts a received logic signal of an unbalanced transmission into a differential signal of a balanced transmission. The receiver converts the received differential signal of the balanced transmission into the logic signal of the unbalanced transmission. The receiver is integrated with a plurality of terminal matching resistors.

Preferably, the receiver includes a plurality pairs of input pins connected with the transmission line. A respective one of the terminal matching resistors is disposed between each pair of the input pins.

Preferably, the terminal matching resistors each have a resistance value in the range of [0.95*R, 1.05*R]. Wherein, R is a standard impedance value, and * is a multiplication operator.

Preferably, the differential signal includes a right low voltage signal, a left low voltage signal, and a clock signal.

Preferably, the differential signal further includes a row data signal and a column polarity control signal.

Preferably, the terminal matching resistors are integrated into an interior of the receiver by means of a semiconductor process.

According to another aspect of the present disclosure, a display device is provided. The display device comprises a display panel and a transmission circuit for transmitting differential signals electrically connected with the display panel. The transmission circuit for transmitting differential signals comprises a transmitter, a receiver, and a transmission line. The transmission line is connected with the transmitter and the receiver. The transmitter converts a received logic signal of an unbalanced transmission into a differential signal of a balanced transmission. The receiver converts the received differential signal of the balanced transmission into the logic signal of the unbalanced transmission. The receiver is integrated with a plurality of terminal matching resistors.

Preferably, the display device further comprises a driving circuit. The display panel includes a display circuit. The transmitter is electrically connected with a signal output end of the driving circuit. The receiver is electrically connected with a signal input end of the display circuit.

Preferably, the driving circuit is provided with a master control chip. The transmitter is integrated into the master control chip. The transmission line is electrically connected with the master control chip and the receiver.

Preferably, the display device is a liquid crystal display.

Preferably, the receiver includes a plurality pairs of input pins connected with the transmission line. A respective one of the terminal matching resistors is disposed between each pair of the input pins.

Preferably, the terminal matching resistors each have a resistance value in the range of [0.95*R, 1.05*R]. Wherein, R is a standard impedance value, and * is a multiplication operator.

Preferably, the differential signal includes a right low voltage signal, a left low voltage signal, and a clock signal.

Preferably, the differential signal further includes a row data signal and a column polarity control signal.

According to a further aspect of the present disclosure, a transmission circuit for transmitting differential signals is provided. The transmission circuit for transmitting differential signals comprises a transmitter, a receiver, and a transmission line. The transmission line is connected with the transmitter and the receiver. The transmitter is electrically connected with a first integrated circuit. The transmitter converts a received logic signal of an unbalanced transmission into a differential signal of a balanced transmission. The receiver is electrically connected with a second integrated circuit. The receiver converts the received differential signal of the balanced transmission into the logic signal of the unbalanced transmission. The receiver is integrated with a plurality of terminal matching resistors. The first integrated circuit and the second integrated circuit are two components on a same circuit board. The terminal matching resistors each have a resistance value in the range of [0.95*R, 1.05*R]. Wherein, R is a standard impedance value, and * is a multiplication operator.

The technical solution of the present disclosure integrates the terminal matching resistors into the interior of the receiver. Compared to the configuration that the terminal matching resistor is directly disposed on the circuit board, the terminal matching resistors of the present disclosure do not occupy the space of the external circuit board, and the terminal matching resistors integrated inside the receiver are small in size, low in production cost, and do not occupy a lot of space of the receiver. This not only reduces the number of components mounted on the external circuit board but also simplifies the structure, and the cost of the transmission circuit for transmitting differential signals is reduced.

### BRIEF DESCRIPTION OF THE DRAWINGS

These and/or other aspects will become apparent and more readily appreciated from the following description of the embodiments, taken in conjunction with the accompanying drawings, in which:

FIG. 1 is a schematic view of a transmission circuit for transmitting differential signals in the related art;

FIG. 2 is a schematic view of a transmission circuit for transmitting differential signals in accordance with an embodiment of the present disclosure;

FIG. 3 is a schematic view of a signal channel of the transmission circuit for transmitting differential signals of FIG. 2;

FIG. 4 is a schematic view of signal transmission of a display device in accordance with an embodiment of the present disclosure; and

FIG. 5 is a block diagram of a display device in accordance with an embodiment of the present disclosure.

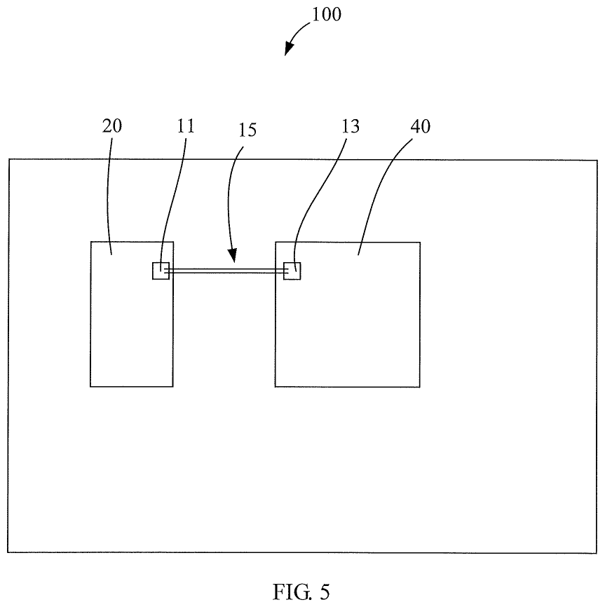

### DESCRIPTION OF THE PREFERRED EMBODIMENTS

Advantages and features of the inventive concept and methods of accomplishing the same may be understood more readily by reference to the following detailed description of embodiments and the accompanying drawings. The inventive concept may, however, be embodied in many different forms and should not be construed as being limited to the embodiments set forth herein.

Throughout the description of the present disclosure, spatially relative terms, such as “upper,” “lower,” “left,” “right,” “front,” “rear,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures.

It will be understood that, although the terms “first,” “second” etc. may be used herein to describe various elements, these elements should not be limited by these terms. These terms are only used to distinguish one element from another. For example, a first element could be termed a second element, and, similarly, a second element could be termed a first element, without departing from the scope of the present disclosure.

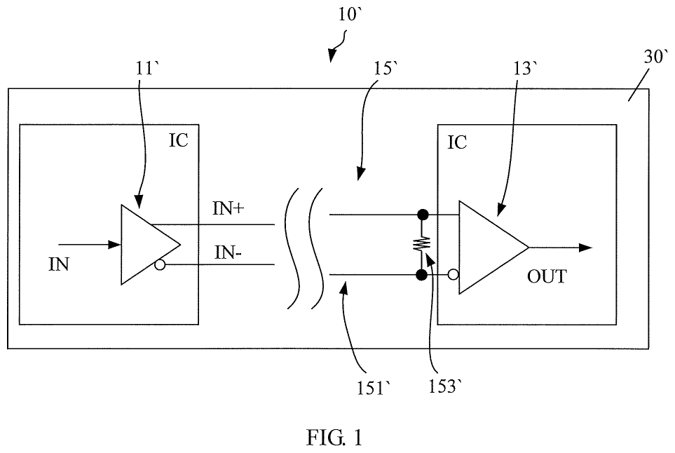

FIG. 1 is a transmission circuit for transmitting differential signals 10′ in the related art. The transmission circuit for transmitting differential signals 10′ comprises a transmitter 11′, a receiver 13′, and an interconnecting device 15′. The interconnecting device 15′ comprises a transmission line 151′ and a terminal matching resistor 153′. The transmission line 151′ may be configured to transmit the data of the transmitter 11′ to the receiver 13′. The terminal matching resistor 153′ may be configured to eliminate the signal reflection on the transmission line 151′. The terminal matching resistor 153′ is usually disposed on a circuit board 30′, which causes a large number of components on the circuit board 30′ and requires other components to be matched when installed, increasing the overall cost of the transmission circuit for transmitting differential signals 10′.

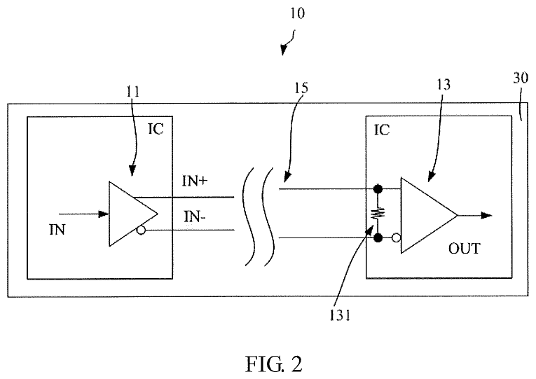

Referring to FIG. 2 to FIG. 4, a transmission circuit for transmitting differential signals 10 in accordance with an embodiment of the present disclosure may be a transmission circuit of mini low-voltage differential signaling (mini-LVDS).

In the present embodiment, the transmission circuit for transmitting differential signals 10 includes a transmitter 11, a receiver 13, and a transmission line 15. The transmission line 15 is connected with the transmitter 11 and the receiver 13.

The receiver 13 is integrated with a plurality of terminal matching resistors 131.

The transmitter 11 is electrically connected with a first integrated circuit (IC). The transmitter 11 may convert a received logic signal of an unbalanced transmission into a differential signal of a balanced transmission.

The receiver 13 is electrically connected with a second IC. The receiver 13 may convert the received differential signal of the balanced transmission into the logic signal of the unbalanced transmission.

The terminal matching resistors 131 are used to eliminate the signal reflection on the transmission line 15.

The transmission line 15 may be a cable or traces on a circuit board.

The first IC and the second IC may be two components on the same circuit board 30 or may be components on two different circuit boards. Referring to FIG. 2, the technical solution of the present embodiment integrates the terminal matching resistors 131 into the interior of the receiver 13. Compared to the configuration that the terminal matching resistor 153′ is directly disposed on the circuit board 30′, the terminal matching resistors 131 of this embodiment do not occupy the space of the external circuit board 30, and the terminal matching resistors 131 integrated inside the receiver 13 are small in size and low in production cost, and do not occupy a lot of space of the receiver 13. This not only reduces the number of components mounted on the external circuit board 30 but also simplifies the structure, and the cost of the transmission circuit for transmitting differential signals 10 is reduced.

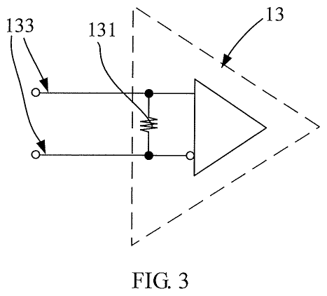

The transmission circuit for transmitting differential signals 10 includes a plurality of signal channels connected the transmitter 11 with the receiver 13. Each pair of output pins (not shown) of the transmitter 11 can be connected to each pair of input pins 133 of the receiver 13 through the transmission line to form a signal channel. A terminal matching resistor 131 (see FIG. 3) may be provided between each pair of input pins 133 of the receiver 13.

Preferably, the resistance value of the terminal matching resistor 131 is in the range of [0.95*R, 1.05*R]. Wherein, R is a standard impedance value, and * is a multiplication operator. The standard impedance value of the terminal matching resistor 131 is Z₀, and the impedance value of the terminal matching resistor 131 is within RT=Z₀* (1±5%). Wherein, the standard impedance value may be 100 ohms.

Preferably, the differential signal includes a right low voltage (RLV) signal, a left low voltage (LLV) signal, and a clock (CLK) signal.

The transmission line 15 is a dual bus structure, and each bus carries the video data of the left half display panel and the right half display panel, respectively. The corresponding buses are denoted as LLV and RLV, respectively.

Each bus may contain a plurality pairs of transmission lines. Each pair of transmission lines carry differential serial video signals and control signals. The number of signal pairs may be determined by the maximum frequency that the column driver of the semiconductor technology can support. The individual signal pairs made up of xLV (x is R or L) are expressed as xLVi. For a bus with (n+1) pairs of data, i is from 0 to n and n is a positive integer. The two wires of xLVi are xLViP and xLViM, and P and M represent the positive and negative wires, respectively. When xLViP voltage is higher than xLViM voltage, xLVi is considered as at a high logic level (the logic value is 1).

Preferably, the differential signal further includes a row data signal and a column polarity control signal.

In addition to the differential signal pairs that can carry the video data, the differential signal may include a row data signal (TP1) and a column polarity control (POL). These two TP1 and POL signals are common level signals of RLV and LLV. TP1 may be a row separator, indicating the end of each row of the data transmission. POL may control the polarity of the output of the column driver.

Preferably, the terminal matching resistors 131 are integrated into the interior of the receiver 13 by means of a semiconductor process, so that the production of the receiver 13 is simple and inexpensive.

The semiconductor process may use a wafer as the basic material. The surface of the wafer is formed with an oxide film and coated with a photosensitizer and then combined with a photomask for exposing and developing, such that the wafer is formed with various types of circuits thereon. After etching, the removal of the photoresist and the addition of impurities, the metal is evaporated for the wiring and electrode of each component to be formed. The wafer is probed for detection and cut into a chip. Through the assembly process of adhesion, wiring and packaging and so on, an electronic product is manufactured.

The present disclosure also discloses a display device 100. The display device 100 includes a display panel and a transmission circuit for transmitting differential signals 10 electrically connected with the display panel. As to the structure of the transmission circuit for transmitting differential signals 10, please refer to the above-described embodiment.

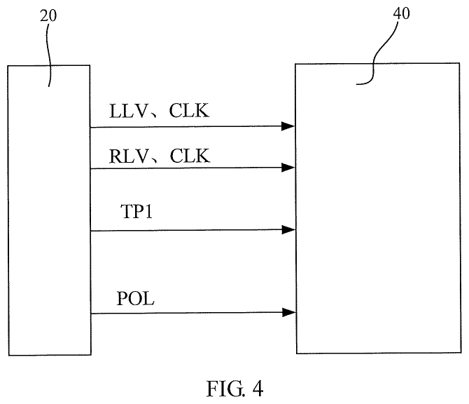

Referring to FIG. 4, the display device 100 includes a driving circuit 20. The display panel includes a display circuit 40. The transmitter 11 is electrically connected with a signal output end of the driving circuit 20. The receiver 13 is electrically connected with a signal input end of the display circuit 40. The transmitter 11 converts an unbalanced logic signal outputted from the driving circuit 20 into a balanced differential signal, and the signal is transmitted to the receiver 13 at the side of the display circuit 40 via the transmission line 15. The receiver 13 converts a balanced transmission differential signal into an unbalanced transmission logic signal to be sent to a sequential control and row and column driving circuit of the display circuit.

The driving circuit 20 may be provided with a master control chip (not shown). The transmitter 11 may be integrated into the master control chip. The transmission line 15 is connected with the master control chip and the receiver 13.

The transmitter 11 is integrated into the master control chip, so the structure of the display device 100 is simple and the assembly process is convenient.

The display device 100 may be a liquid crystal display or a light emitting diode (LED) display. The display device 100 may be a computer display, a television display or a mobile phone display or the like.

The transmission circuit for transmitting differential signals and the display device provided by the present disclosure can simplify the transmission circuit for transmitting differential signals and reduce the cost.

Although particular embodiments of the present disclosure have been described in detail for purposes of illustration, various modifications and enhancements may be made without departing from the spirit and scope of the present disclosure. Accordingly, the present disclosure is not to be limited except as by the appended claims.

What is claimed is:

1. A transmission circuit for transmitting differential signals, comprising a transmitter, a receiver, and a transmission line, wherein the transmission line is connected to the transmitter and the receiver;
wherein the transmitter is configured to convert a received logic signal of an unbalanced transmission into a differential signal of a balanced transmission;
wherein the receiver is configured to convert the received differential signal of the balanced transmission into the logic signal of the unbalanced transmission; and
wherein the receiver is integrated with a plurality of terminal matching resistors.

2. The transmission circuit for transmitting differential signals as claimed in claim 1, wherein the receiver includes a plurality pairs of input pins connected with the transmission line, and a respective one of the terminal matching resistors is disposed between each pair of the input pins.

3. The transmission circuit for transmitting differential signals as claimed in claim 2, wherein the terminal matching resistors each have a resistance value in a range of [0.95*R, 1.05*R], wherein R is a standard impedance value, and * is a multiplication operator.

4. The transmission circuit for transmitting differential signals as claimed in claim 1, wherein the differential signal includes a right low voltage signal, a left low voltage signal, and a clock signal.

5. The transmission circuit for transmitting differential signals as claimed in claim 2, wherein the differential signal includes a right low voltage signal, a left low voltage signal, and a clock signal.

6. The transmission circuit for transmitting differential signals as claimed in claim 3, wherein the differential signal includes a right low voltage signal, a left low voltage signal, and a clock signal.

7. The transmission circuit for transmitting differential signals as claimed in claim 4, wherein the differential signal further includes a row data signal and a column polarity control signal.

8. The transmission circuit for transmitting differential signals as claimed in claim 5, wherein the differential signal further includes a row data signal and a column polarity control signal.

9. The transmission circuit for transmitting differential signals as claimed in claim 6, wherein the differential signal further includes a row data signal and a column polarity control signal.

10. The transmission circuit for transmitting differential signals as claimed in claim 1, wherein the terminal matching resistors are integrated into an interior of the receiver by means of a semiconductor process.

11. The transmission circuit for transmitting differential signals as claimed in claim 2, wherein the terminal matching resistors are integrated into an interior of the receiver by means of a semiconductor process.

12. A display device, comprising a display panel and a transmission circuit for transmitting differential signals electrically connected with the display panel;
wherein, the transmission circuit for transmitting differential signals comprises a transmitter, a receiver, and a transmission line; the transmission line is connected with the transmitter and the receiver; the transmitter is configured to convert a received logic signal of an unbalanced transmission into a differential signal of a balanced transmission; the receiver is configured to convert the received differential signal of the balanced transmission into the logic signal of the unbalanced transmission; and the receiver is integrated with a plurality of terminal matching resistors.

13. The display device as claimed in claim 12, further comprising a driving circuit, wherein the display panel includes a display circuit, the transmitter is electrically connected with a signal output end of the driving circuit, and the receiver is electrically connected with a signal input end of the display circuit.

14. The display device as claimed in claim 13, wherein the driving circuit is provided with a master control chip, the transmitter is integrated into the master control chip, and the transmission line is electrically connected with the master control chip and the receiver.

15. The display device as claimed in claim 12, wherein the display device is a liquid crystal display.

16. The display device as claimed in claim 12, wherein the receiver includes a plurality pairs of input pins connected with the transmission line, and a respective one of the terminal matching resistors is disposed between each pair of the input pins.

17. The display device as claimed in claim 16, wherein the terminal matching resistors each have a resistance value in a range of [0.95*R, 1.05*R], wherein R is a standard impedance value, and * is a multiplication operator.

18. The display device as claimed in claim 12, wherein the differential signal includes a right low voltage signal, a left low voltage signal, and a clock signal.

19. The display device as claimed in claim 18, wherein the differential signal further includes a row data signal and a column polarity control signal.

20. A transmission circuit for transmitting differential signals, comprising a transmitter, a receiver, and a transmission line;
wherein,
the transmission line is connected with the transmitter and the receiver;
the transmitter is electrically connected with a first integrated circuit, the transmitter is configured to convert a received logic signal of an unbalanced transmission into a differential signal of a balanced transmission;
the receiver is electrically connected with a second integrated circuit, the receiver is configured to convert the received differential signal of the balanced transmission into the logic signal of the unbalanced transmission; and the receiver is integrated with a plurality of terminal matching resistors;
the first integrated circuit and the second integrated circuit are two components on a same circuit board; and
the terminal matching resistors each have a resistance value in a range of [0.95*R, 1.05*R], wherein R is a standard impedance value, and * is a multiplication operator.
